(19) United States
(12) Patent Application Publication
(10) Pub. No.: US 2016/0029186 A1
(43) Pub. Date: Jan. 28, 2016

(54) COMMUNICATIONS SYSTEM FOR FILTERING RECIPIENTS BASED UPON GEOGRAPHICAL PROXIMITY

(71) Applicant: Be Heard, LLC, Wall, NJ (US)

(72) Inventors: Ryan DeMattia, Greenville, SC (US); Aanarav Sareen, New York, NY (US); Adam DeMattia, Holly Springs, NC (US)

(73) Assignee: Be Heard, LLC, Wall, NJ (US)

(21) Appl. No.: 14/808,087

(22) Filed: Jul. 24, 2015

Related U.S. Application Data
(60) Provisional application No. 62/028,683, filed on Jul. 24, 2014.

(51) Int. Cl. H04W 4/14; H04W 4/02; H04L 12/58

(52) U.S. Cl. CPC H04W 4/14; H04L 51/20; H04W 4/021

(57) ABSTRACT

A system for communications between senders and recipients within a geographic location comprising: a portable device having a transceiver, GPS receiver, display and device computer readable medium; a server in communications with the portable device having a server computer readable medium; a database of records representing potential recipients in communications with the server wherein each record includes a unique user id and is associated with a user's portable device wherein each portable device includes current geolocation information; and, a set of device computer readable instructions on the device computer readable medium for creating message, associating a broadcast distance with the message, transmitting the message to the server to deliver to users within a distance represented by the broadcast distance relative to the device geolocation information.

### CLAIM OF PRIORITY

The application claims priority on U.S. Patent Provisional Application 62/028,683 filed on Jul. 24, 2014.

### BACKGROUND OF THE INVENTION

1) Field of the Invention

The present invention relates to a system for sending messages to selected recipients based upon the recipient's geographic proximity to the sender. More specifically, the sender can determine which recipients will receive a message based upon the selected geographic proximity of the recipient to the sender.

2) Description of Related Art

Currently, instant messaging (IM), texting and video conferencing are features integrated in most smart phones. Further, most smart phones (e.g. iPhones) include a transceiver for sending and receiving electronic information over wireless networks. Most smart phones also include a GPS receiver and can determine the geolocation of the smart phone using a satellite-based location system implemented by the U.S. Department of Defense. The smart phone includes a GPS receiver that receives location information and use the received information to calculate the smart phone's exact location on the globe.

In some smart phones, A-GPS (“Assisted GPS”) is used. The technology accesses an intermediary server when it is not possible to connect directly via satellite and relies on this server to provide additional information to make it possible to more accurately determine a smart phone's position.

Further, smart phones can use “wi-fi hotspots” and cellular towers to provide a more accurate location.

When a sender wishes to send the message to the recipient, the sender selects the recipient and sends the IM communications or the text to that recipient. One of the benefits of this feature is that group messages can be created that include multiple recipients. When any one of the recipients replies to the original message, the remained recipients and the sender receives the reply. Such instant communications can be used for organizing meeting places, physically meeting at events with large crowds, or otherwise coordinating efforts of the participants in the communications.

One disadvantage is that once one is in such a communications, that the recipient gets each reply of the group until the recipient deletes the communication thread. This functionality is not geographically based, but rather limited only to those recipients selected by the sender regardless of the recipient's physical location. Lack of the geographic limits leads to inefficiencies and unnecessary recipients to communication threads. For example, if the sender is seeking all the sender contacts for a social event (movie, dinner and the like) that are in the general proximity of the sender so that an invitation can be sent, the sender can only send a message and hope that some of the recipients are within a sufficient distance to effectively respond to the invitation and arrive at the event within a timely fashion. Otherwise, recipients are receiving invitations to events that are not relevant as the recipient would not be able to attend based upon distance.

One attempt to provide this functionality of the location feature of smart phones is that it can transmit the location of the recipient to the sender prior to the sending of the message. This location information is taken from GPS coordinates and provides for a very accurate location of the recipient. However, may recipients do not wish to share their specific physical location based upon concerns for safety, privacy or other factors. Therefore, the recipient's option to turn off this feature is detrimental to limited communications to those that are within a sufficient physical proximity to make the communications relevant.

Accordingly, it is an object of the present invention to provide for a communications system that can limit recipients of certain communications to a pre-selected geographic proximity to the sender.

It is another object of the present invention to provide for a messaging system where the message communications are limited to senders and receives within a specific geographic location.

### SUMMARY OF THE INVENTION

The above objectives are accomplished according to the present invention by providing a system for a system for communications between senders and recipients within a geographic location comprising: a portable device having a transceiver for receiving device geolocation information, location receiver and device computer readable medium; a server in electronic communication with the portable device; a database of messages wherein each message has message information including sender information, content, message geolocation information; and, a set of device computer readable instructions on the device computer readable medium included with the portable device, that transmits the geolocation information to the server, receives message information from the server for message information that are within a first pre-determined distance from the portable device when compared to the message geolocation information and displays the sender information, content, sender id and geolocation information for each received message.

The set of device computer readable instructions can include instructions for only retrieving a pre-determined number of messages. The pre-determined number of messages can be less than 100. The set of device computer instruction can include instructions for retrieving message information outside the first pre-determined distance and within a second pre-determined distance. The first pre-determined distance can be about 30 meters and the second pre-determined distance is about 300 meters. The computer readable instructions include instructions for retrieving message information outside the second pre-determined distance and within a third pre-determined distance. The device computer readable instructions can include instructions to associate the device geolocation information with a received message and transmit the message and device geolocation information to a second recipient providing a retransmitted message. The device computer readable instructions can include instructions to display the number of times the message is retransmitted. The device computer readable instructions can include instructions to associate the device geolocation information with the received message, and transmit the message to user's within a first pre-determined distance of the device geolocation information.

The device computer readable instructions include instructions can receive a retransmitted message from a second portable device and display the geolocation of the second portable device and the geolocation information of the message information of the retransmitted message. The portable device can transmit the device geolocation information to the server at pre-determined intervals. The pre-determined intervals can be selected from the group consisting of 0, 5, 15 and 30 minutes. The first pre-determined distance can be represented by a first circle surrounding the device geolocation information when displayed to a user. The computer readable instructions can include instructions for displaying a second circle representing the second pre-determined distance having a distance greater than the first circle. The device computer readable instructions can include instructions for displaying potential recipients of message information where the recipient is located within a first pre-determined distance. The geolocation information is retrieved from the global positioning satellite information.

This invention can be a system for communications between senders and recipients within a geographic location comprising: a portable device having a transceiver, GPS receiver, display and device computer readable medium; a server in communications with the portable device having a server computer readable medium; a database of users records contained on a database in communications with the server wherein each user record includes a unique user id and is associated with a user's portable device; and, a set of device computer readable instructions on the device computer readable medium for receiving device geolocation information, transmitting the device geolocation information to the server, retrieving messages associated with a user from the server having message geolocation information that are within a first distance of the portable device calculated according to the message geolocation information and the user current geolocation information, displaying the received user id, message and message geolocation information associated with each retrieved message on the device display.

The invention can be a system for communications between senders and recipients within a geographic location comprising: a portable device having a transceiver, GPS receiver, display and device computer readable medium; a server in communications with the portable device having a server computer readable medium; a database of records representing potential recipients in communications with the server wherein each record includes a unique user id and is associated with a user's portable device wherein each portable device includes current geolocation information; and, a set of device computer readable instructions on the device computer readable medium for creating message, associating a broadcast distance with the message, transmitting the message to the server to deliver to users within a distance represented by the broadcast distance relative to the device geolocation information.

### BRIEF DESCRIPTION OF THE DRAWINGS

The construction designed to carry out the invention will hereinafter be described, together with other features thereof. The invention will be more readily understood from a reading of the following specifications and by reference to the accompanying drawings forming a part thereof, wherein an example of the invention is shown and wherein:

FIGS. 1 through 3 are flowcharts of the invention;

FIG. 4 shows a schematic of the invention;

FIGS. 5 and 6 show aspects of the invention directed to the login features;

FIGS. 7 and 8 show aspects of the invention directed to the registration of a user;

FIG. 9 shows aspects of the invention related to the display screen (Hub);

FIG. 10 shows aspects of the invention related to the point-to-point or private messages (Whisper);

FIG. 11 shows aspects of the invention related to the range map and its display;

FIG. 12 shows aspects of the invention related to the creation of a new message (voice);

FIG. 13 shows aspects of the invention related to the search feature;

FIGS. 14 and 15 show aspects of the invention related to the profile and contact management features;

FIG. 16 shows aspects of the invention related to logging out; and,

FIGS. 17 and 19 shows screens of one embodiment.

### DETAILED DESCRIPTION OF A PREFERRED EMBODIMENT

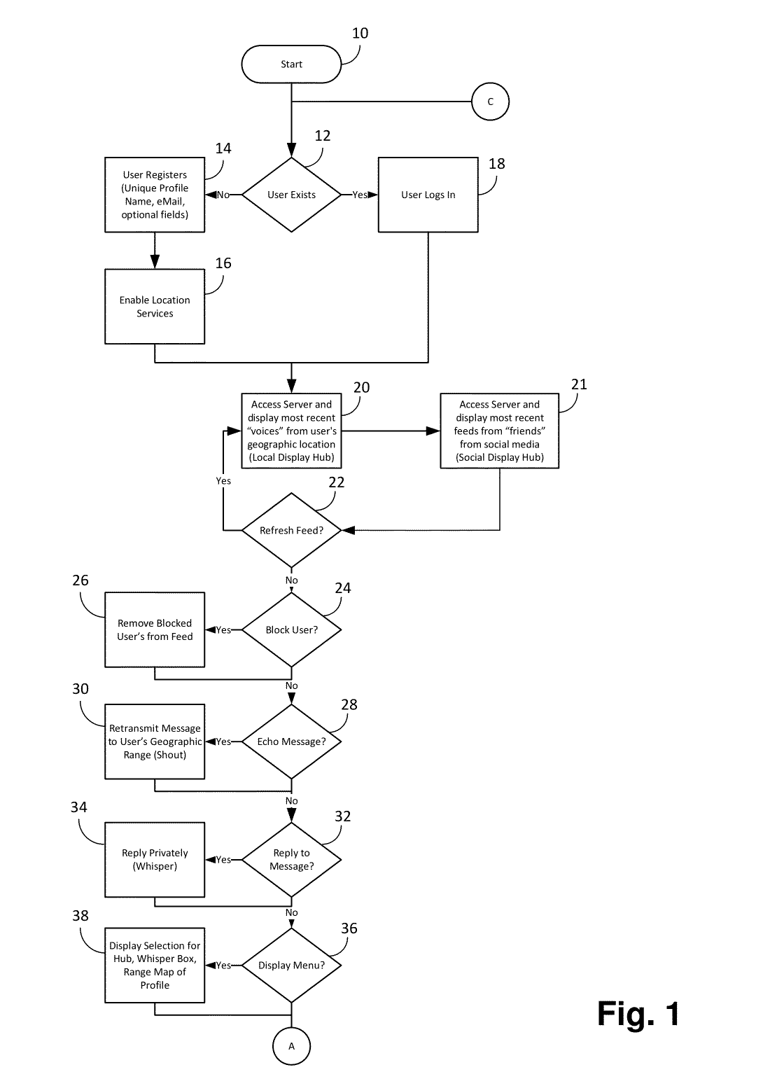

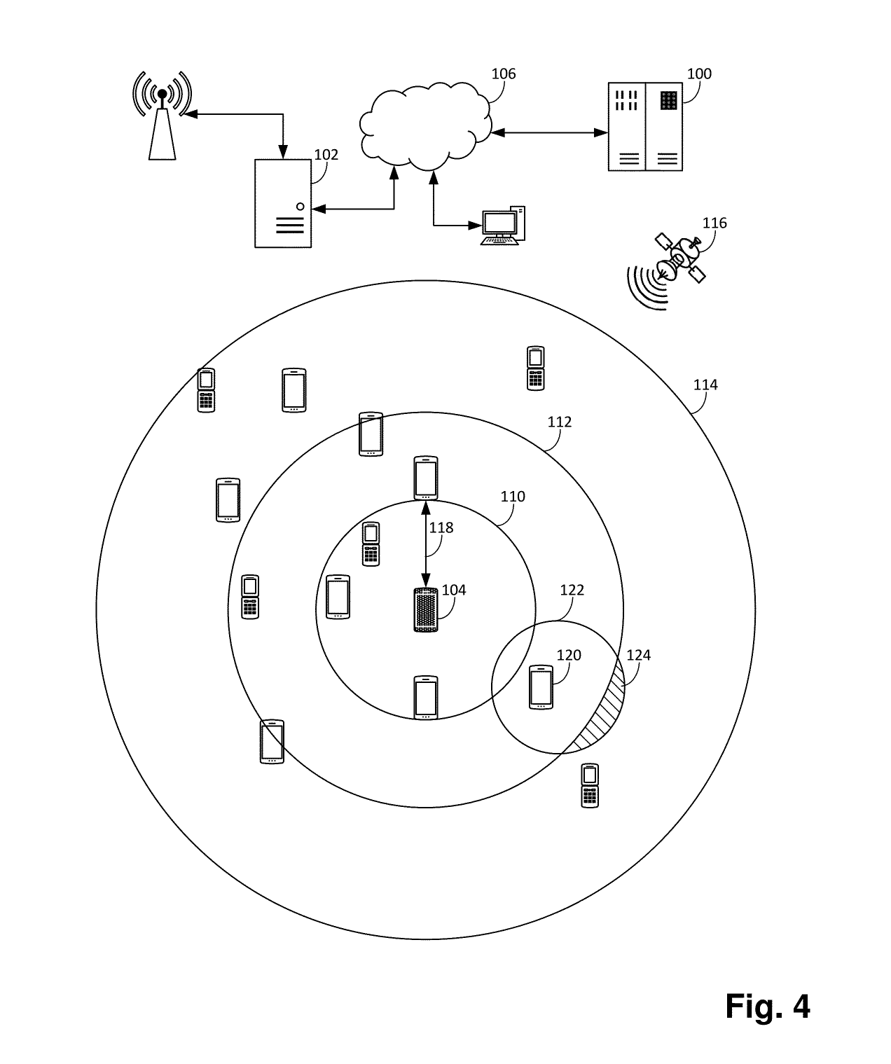

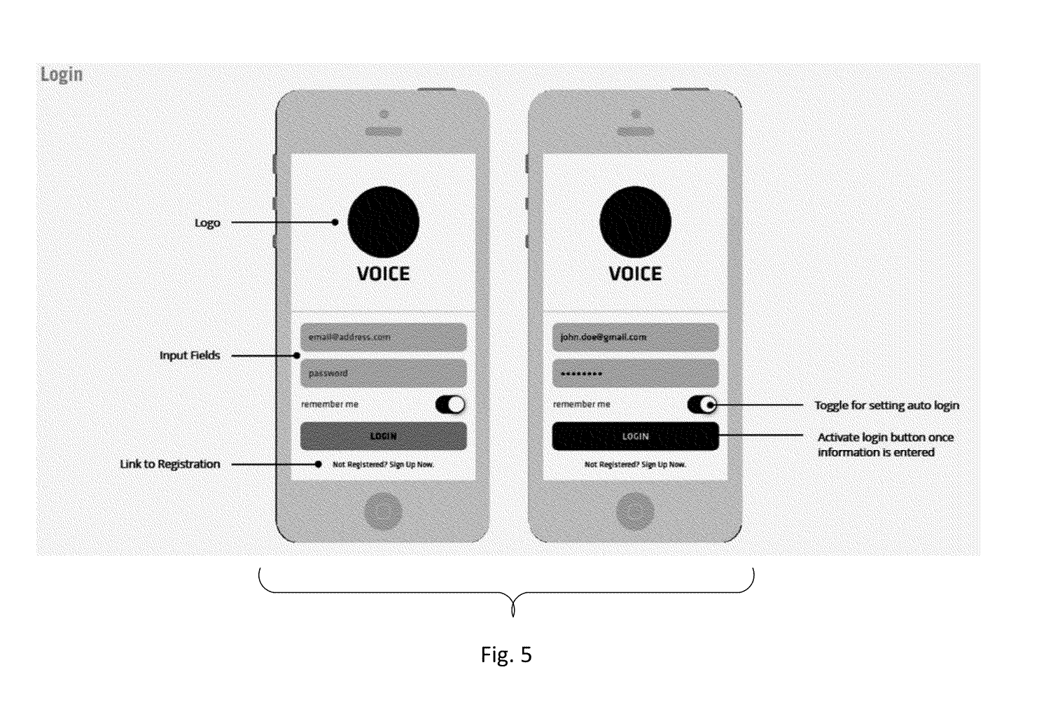

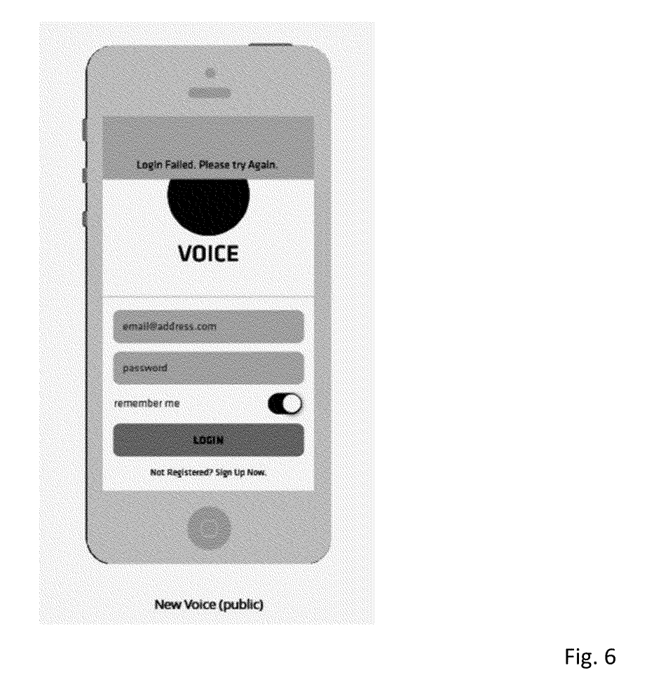

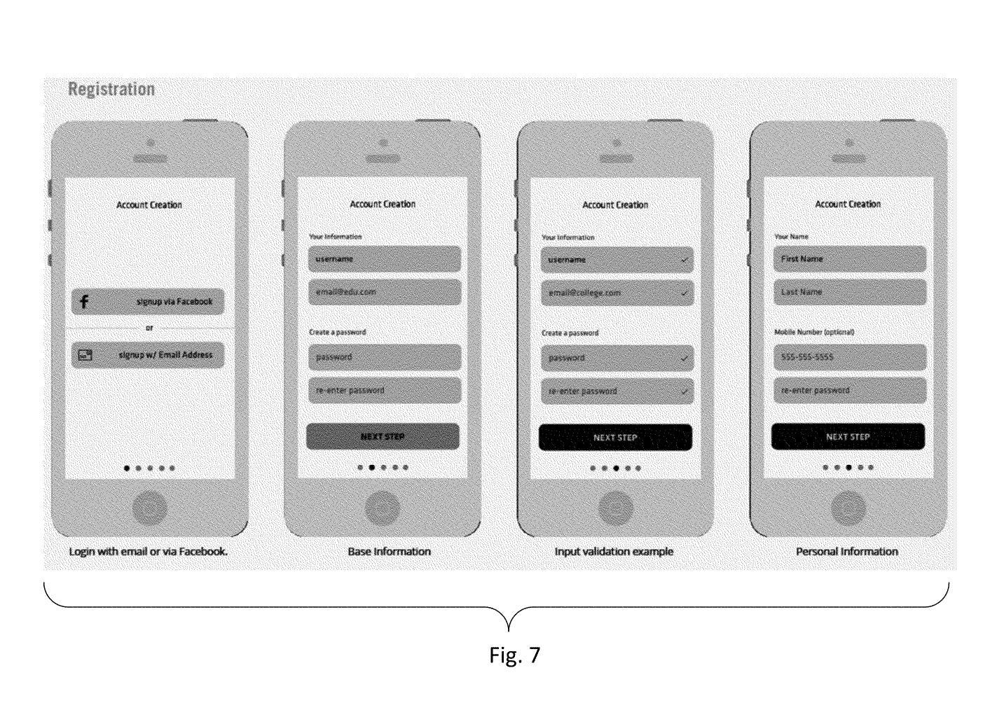

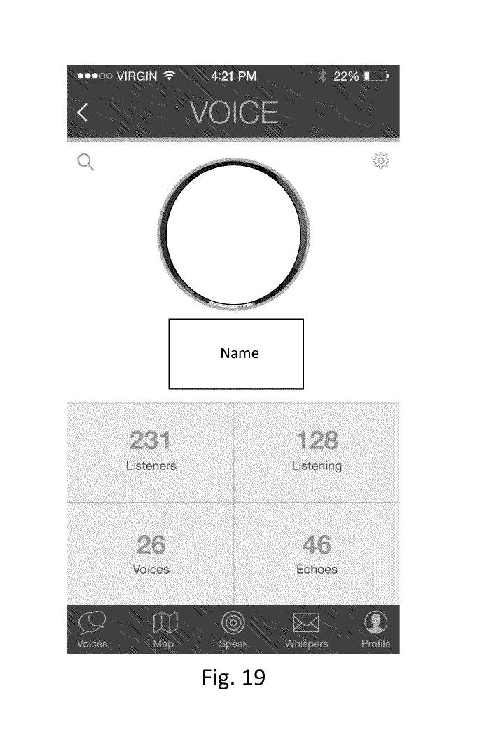

Referring to FIG. 1, the computer readable code, specifically designed to provide the functionality and physical manipulation described herein, begins at step 10. A determination is made at step 12 to see if the user already has a user id. The user id can be used to create a sender id and recipient id representing user in their respective roles. The user is presented with log-in (email address and application password) when accessing the application without authentication. The user is given the option to remember log in information in order to subsequently bypass login (FIGS. 5 and 6). The user is able to retrieve their password via an email reminder. If the user needs to create an account (initial registration) at 14, the user must enter a unique profile name. The profile name is verified against the database stored on a server 100 (FIG. 4). If the user name is not unique, the user is prompted to enter a different name. The user must also enter a unique email address. The email addresses are verified against the server. If the email address is not unique, the user is prompted to enter a different email address. A confirmation email is sent to the user upon successful registration. Optional fields that can be completed at the initial registration include: age, sex, photo or avatar, and a 50 character biography for the user. The user can access the profile of another registered user at any time via the profile feature of the main menu. The user can edit their profile. All fields can be editable, including email address; however, email uniqueness verification must be performed. A profile photo (thumbnail) can be viewed full size. FIG. 7 illustrates screens of the process in one embodiment. FIG. 19

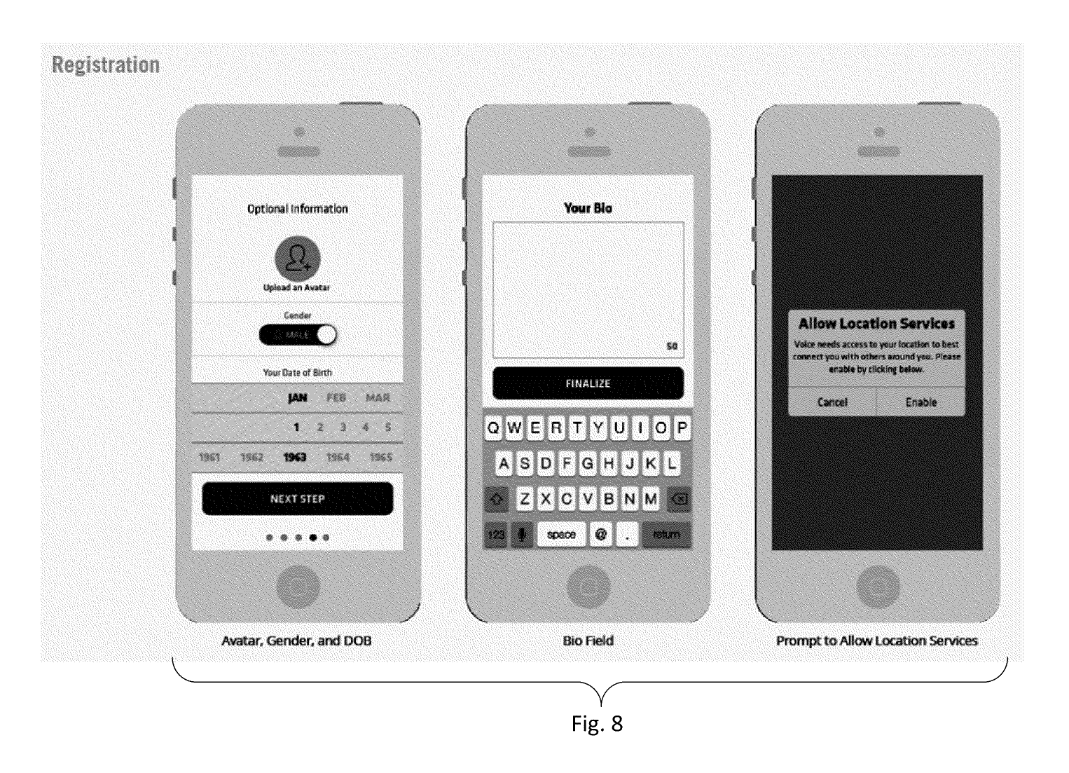

The user must also activate the location function at 16 so that the location of the user will be transmitted to the server. This location need not be transmitted to other users so that the exact location of each user need not be shared with the other users. FIG. 8 illustrates screens of the process in one embodiment.

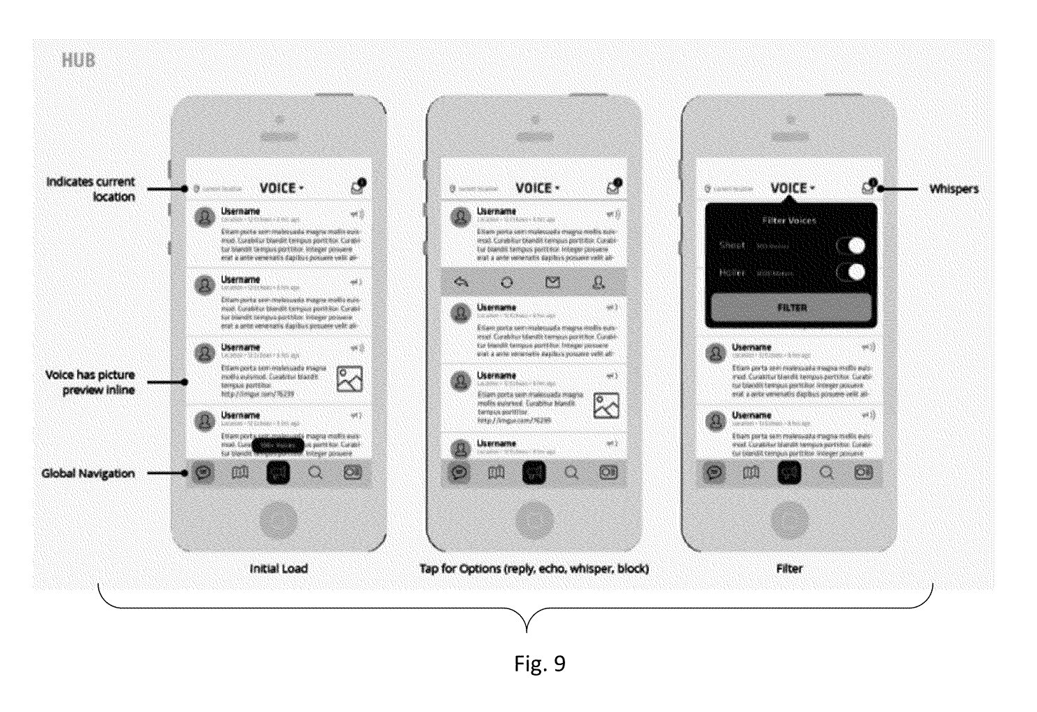

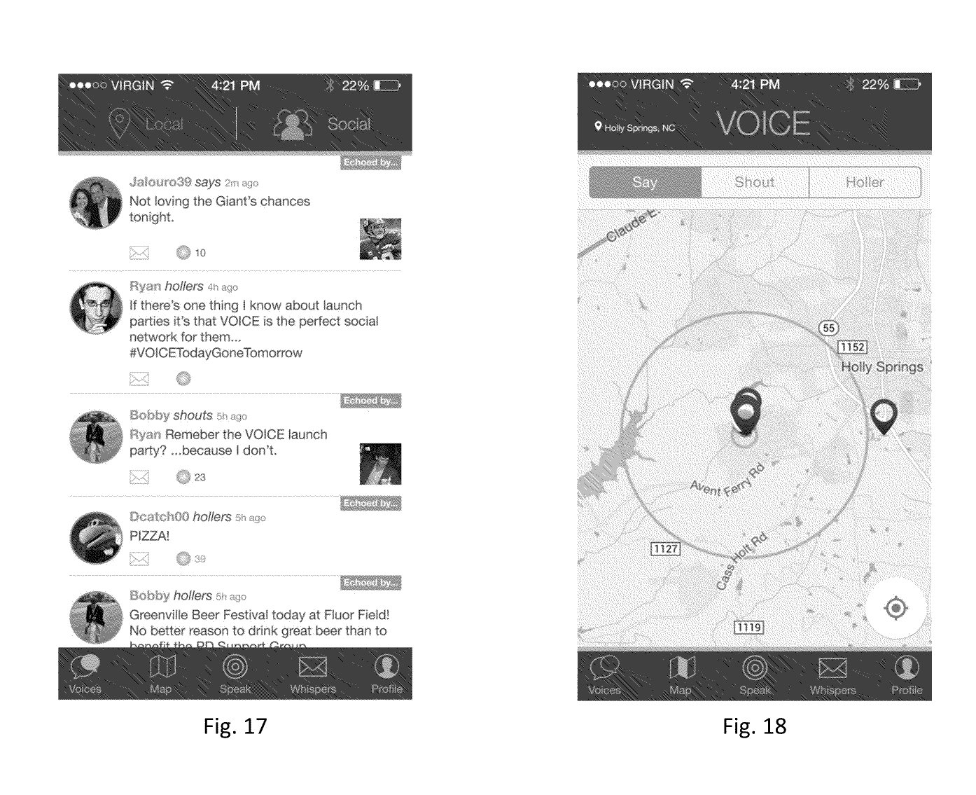

Once the user is logged in at 18 or after initial registration, the main screen (HUB) is displayed to the user at 20. FIG. 9 illustrates screens of the process in one embodiment. FIG. 17 illustrates the main screen in one embodiment. The server is then pinged and the most recent 100 messages or voices that are within a predetermined distance from the user's current geographic location are retrieved from the server and transmitted to the user. Voices will have an indicator as to whether the voice was a say, shout, or holler. The terms Say, Shout and Holler represent broadcast distances associated with the message so that only recipients within a certain geographic distance will receive the message. In one embodiment, a say is a message from a user that is within about a 30 meter diameter circle of the user. A Shout is within about 300 meters and a Holler is within about 3000 meters. These distances need not be exact, but the diameter of the say is smaller than the diameter of the shout which is smaller than the diameter of the holler. The user is able to refresh the feed at 22 so that the most recent 100 voices at that time, from a predetermined distance of the user's geographic location, will be loaded.

Further, the user can access profiles of the other users that are within the predetermined distance (Say, Shout or Holler) of the user. The user is given knowledge that the other user(s) is within a certain proximity but is not necessarily provided with that user's specific physical location information. In one embodiment as 21, the user is presented with the ability to receive and review message, notifications, images, videos and the like from social media. These messages can be from “friends”, third parties regardless of geolocation of the sender or limited to within a pre-determined distance of the user. The pre-determined distance can be the distance associated with the Say, Shout or Holler.

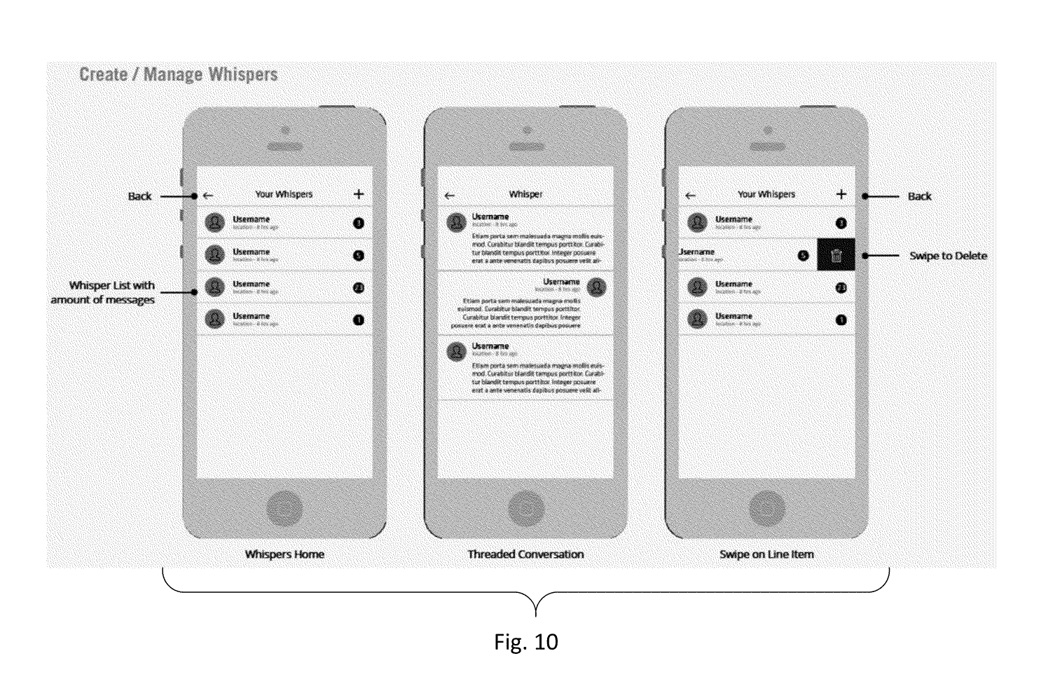

Each voice in the Hub screen is accompanied by a user name, profile photo, time since voice was submitted, and voice type. Individual voices (communications or messages) will have an indicator as to whether the voice was a Say, Shout or Holler. The user can access the history of the voice (i.e., where it originated from, how far it's travelled). User can filter the Hub by voice type (i.e., Say, Shout, and Holler). The user can block another user. The blocked user will no longer appear on the user's Hub at 24-26. At 28-30, the user can echo a voice from their Hub. Echoing a voice means that it gets shouted by the user to his/her geographic range, but still maintains the properties of the original voice. The user can reply to a voice at 32 and it can be done privately at 34. Doing so opens up a new Whisper message (a message that is point to point), pre-addressed to the original poster. Only the original poster will see this Whisper. FIG. 10 illustrates screens of the Whisper on one embodiment.

The user can create their own new voice from the Hub. The user can delete their own message from the Hub after they've sent it. If links to photos appear on the feed, a preview of the photo will be displayed. A menu can persists on the screen of a smart phone enabling the user to select Hub, Whisper Box, Range Map or Profile. The menu can be retrieved by the user at 36 and displayed at 38.

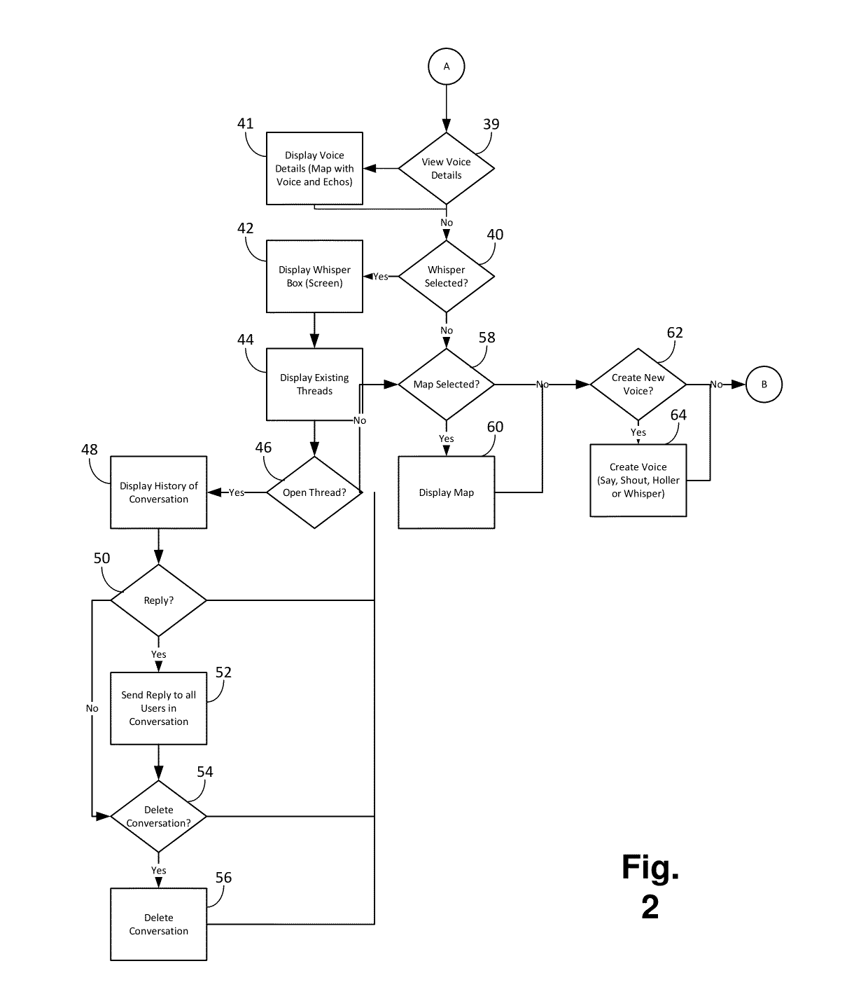

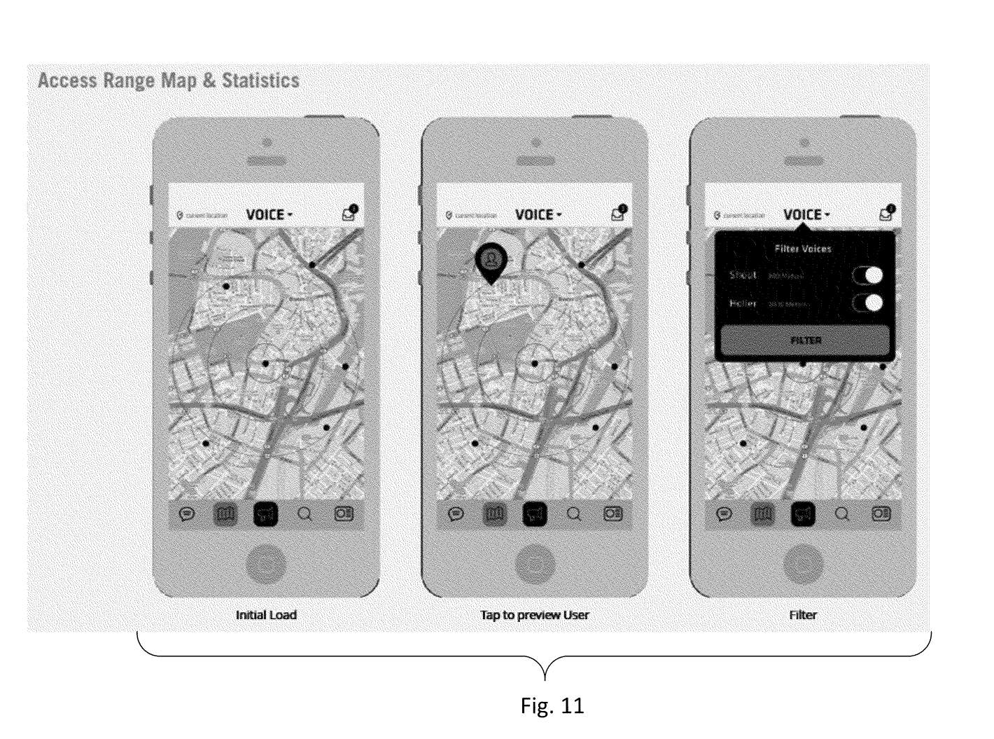

Referring to FIG. 2, the user can select a particular voice at 39 and view voice (message) details at 41. The details can include a selection between the local message (voices) and social media message, the message information, message type (Say, Shout, Holler or Whisper), retransmission (echo) information, images associated with the message creator, map display, attachment options, and the like. The user can also view whispers by individual message, groups or threads. FIGS. 11 and 18 illustrates map screens in embodiments of the invention.

From the menu the user may also select a Whisper Box at 40. If so, the Whisper Box is displayed at 42. The user can address a Whisper to a single contact or multiple contacts at once. A Whisper will be received by the addressed contact(s) within their Whisper Box. Whispers do not necessarily appear in the Hub. When a Whisper is sent or received for the first time, a new conversation thread is started in the Whisper Box. User can open a conversation thread from the Whisper Box to view the history of the conversation at 44. For each Whisper within the conversation thread, the username, profile picture, time of Whisper, and content of Whisper is displayed. The user can open the thread and view the conversations at 46-48. The user can reply to a conversation thread at 50-52. All contacts in the conversation will receive the reply. The user can delete a conversation at 54-56.

The map can be selected at 58 and displayed at 60. When the map page is accessed for the first time, GPS location services show the user where the user is located. Three concentric circles appear around the user's location, displaying the potential range of each voice type (i.e., Say, Shout or Holler). User can create a new voice from the Map screen. The user can re-establish GPS location manually by refreshing the map.

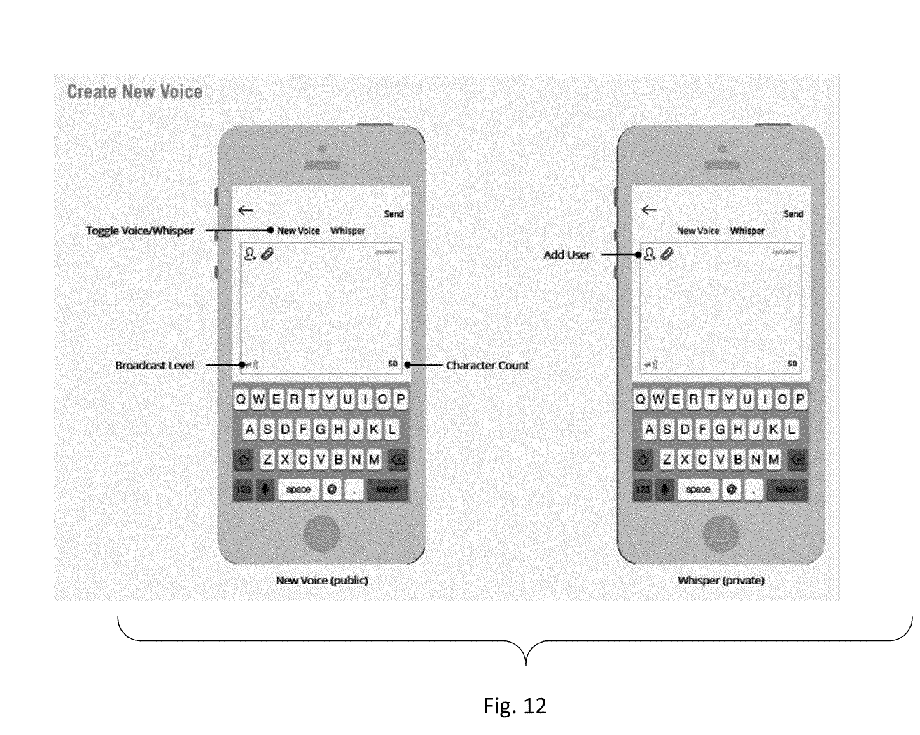

In creating a new voice (message) at 62-64, the user is presented with a text field to enter up to 150 characters or more per message. The user can choose to say, shout or holler their message. The user can delete the draft message before it is sent. The user gets prompted to confirm they want to delete the message. If the user chooses to delete, they get returned to their Hub. If the user chooses to cancel the delete operation, user gets returned to the draft message, still intact. When typing the message, the user can tag someone from their contact list in the message. When the tagged person appears in voice, their name is a hyperlink to their profile, accessible by anyone reading the voice. The user can access the voice Range Map screen from the new voice screen. FIG. 12 illustrates screens of the range map in one embodiment.

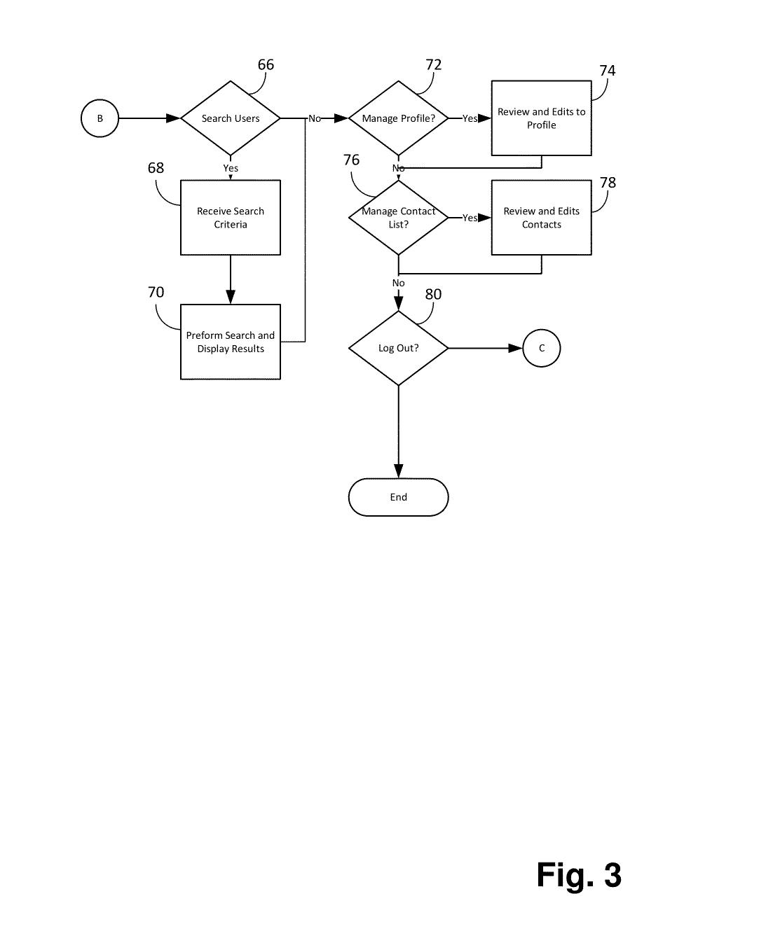

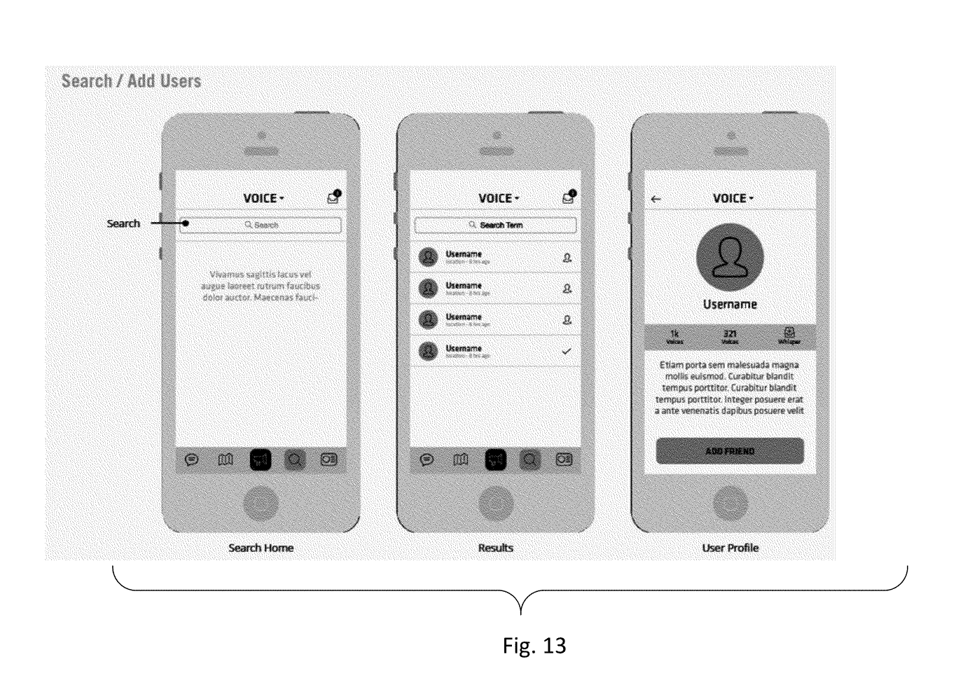

The user can search for other users at 66 on FIG. 3. The user can enter an email address or user name to search all registered users at 68. Search results include summary profile for each hit (i.e., thumbnail profile pic., user name, and bio.) at 70. The user can access the profile for any displayed user. The user can add other users to their contact list. The user can clear search results and search history. FIG. 13 illustrates screens of this process in one embodiment.

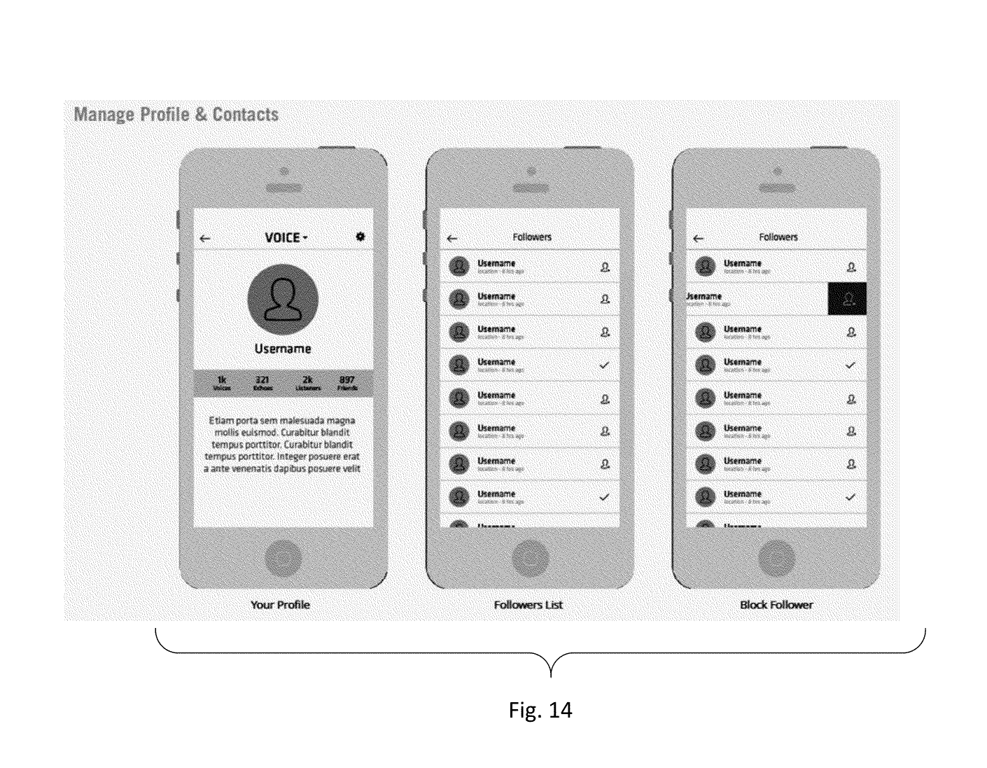

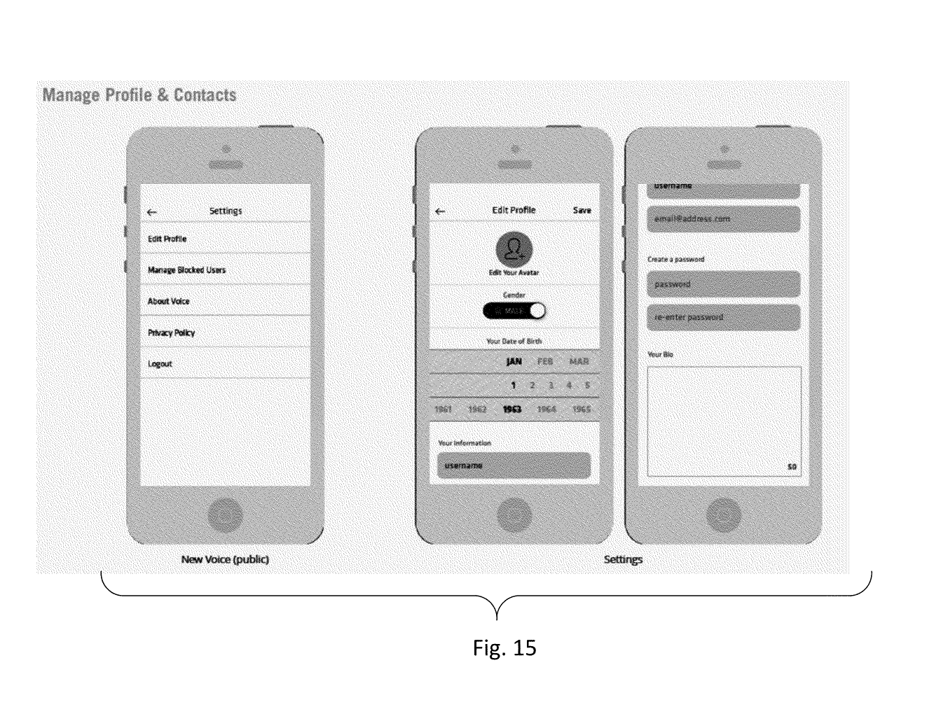

The user can manage his or her profile at 72-74. A user photo, user name and bio appear by default when the profile screen is selected. A Contact list appears alphabetically below the user's profile and can be modified at 76-78. An alphabetical vertical menu is available for faster navigation. When a contact is tapped, the contact's profile appears at the top of the screen. (i.e., the space for the user's profile is context sensitive to the contact list). The user can initiate a Whisper to a contact from within the contact's profile. The user has the ability to delete a contact. When a contact is deleted, it no longer appears in the user's Contact list. The user has the ability to block a contact. When a contact is blocked, the contact's profile no longer appears in the user's Contact list. The contact's voice will also never appear in the user's Hub. FIGS. 14-15 illustrate screens for this process in one embodiment.

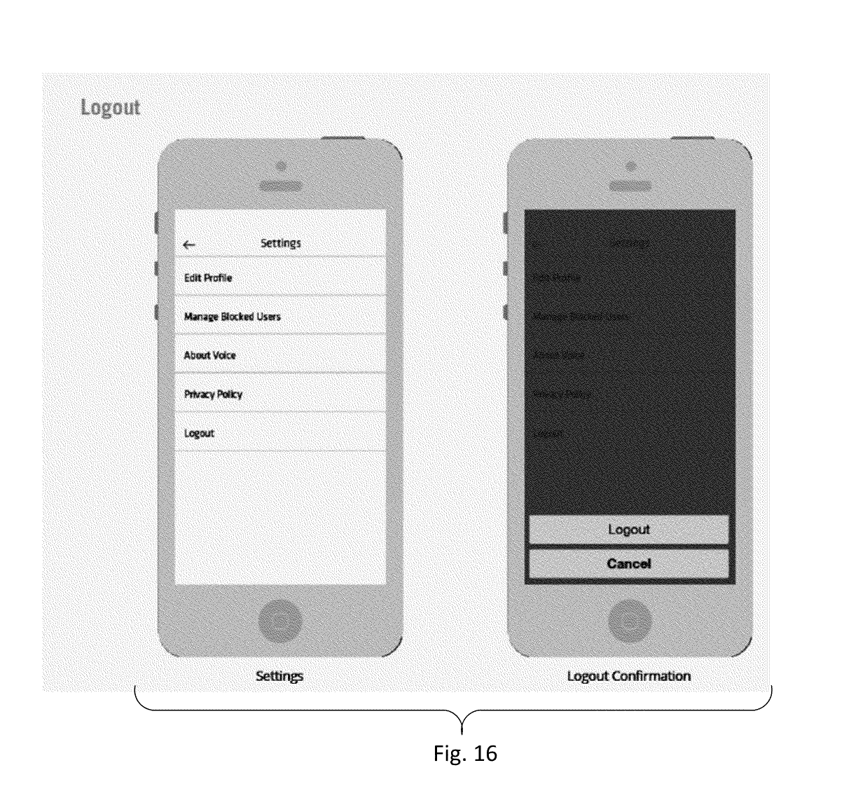

Additional settings available for the user includes the ability to choose to turn on/off push notifications for incoming Whispers. The user can choose to turn on/off push notifications for public voices that the user was tagged in. The user can choose to set a frequency of automatic GPS pings to the server. Options include every minute, every 5 minutes, every 15 minutes, every 30 minutes, or never. The user is able to enter and update user information such as linked email address (required field), password (required field), birthday (optional field), and gender (optional field). The user is able to set privacy settings. Privacy settings include whether the user can be located via searches (e.g., search by email address) and whether or not the user can receive Whispers from people outside of their contact list. A User Profile can be deleted at any time. Verification email is sent to associated email address. The user can log out at 80. FIG. 16 illustrates screens for this process in one embodiment.

Referring to FIG. 4, server 10 is in communications to a wireless server or service 102 so that the server can communicate with various portable devices such as 104 that can be a smart phone. The portable device can include a transceiver, location receiver (such as a GPS receiver), computer readable medium, power supply, housing, camera, speaker microphone display and processor. The wide area network 106 can be the communications between the wireless service and the server. A personal computer can be in communications with the server and provide the same or similar functionality to that of the portable device and as described herein.

As used herein the term Say could be the geographic area 110 so that when recipients are sent a message (Voice) that is designed Say, it is transmitted to users selected by the sender, but only if those users are within the distance 110. A Shout can be circle 112 and Holler can be circle 114. The portable devices can have geolocation information provided to by an external source such as GPS satellites 116, Wi-Fi or cellular towers. Therefore, the message (voice) can be limited in range as to its transmission area. The voice can be public or private at the user's election. The voice can include attachments such as images, voices, messages, text and the like. Further, users can “tag” other users in voices.

The various voices can be represented with colors so that the holler, shout and say are all represented by distinct colors. In one embodiment, a Holler can be represented with colors that include (in hex) 94cc7a, 404040, afafaf, a Shout with c2dead, b8b8b8 and 94cc7a and Say with eaf3e0, 838383 and 79b45d.

A Whisper would be point-to-point communications 118 between a sender and specifically designated recipient. An Echo is the ability to retransmit a message from sender 104 to recipient 120. An Echo is effectively a retransmitted message. The recipient 120 can then retransmit (Echo) the message so that it is sent to recipients within circle 122. This provides for additional transmission area 124 where the message can be received.

Computer readable instructions, when executed by a computer processor, causes the computer to perform a series of steps to accomplish a specific task and resulting in useful, concrete and tangible results adding substantially more to the operation of a general computer. This computer readable code is tied to a particular machine or apparatus with the specific purpose of executing the computer readable code for accomplishing tangible results and represents and accomplishes the manipulation of physical data.

The detailed description herein may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result, when executed by a computer and its processor representing or resulting in the tangible manipulation of physical objects. These steps also require physical manipulations of physical quantities such as electrical or magnetic physical elements and are capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code.

Elements of the flowchart support combinations of means for performing the special functions, combination of steps for performing the specified functions and program instruction means for performing the specified functions. It will be understood that each block of the flowchart illustrations can be implemented by special purpose hardware-based computer systems that perform the specified functions, or steps, or combinations of special purpose hardware or computer instructions.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn there from, alone or with consideration of the references incorporated herein.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A system for communications between senders and recipients within a geographic location comprising:
a portable device having a transceiver for receiving device geolocation information, location receiver and device computer readable medium;
a server in electronic communication with the portable device;
a database of messages wherein each message has message information including sender information, content, message geolocation information; and,
a set of device computer readable instructions on the device computer readable medium included with the portable device, that transmits the geolocation information to the server, receives message information from the server for message information that are within a first pre-determined distance from the portable device when compared to the message geolocation information and displays the sender information, content, sender id and geolocation information for each received message.

2. The system of claim 1 wherein the set of device computer readable instructions include instructions for only retrieving a pre-determined number of messages.

3. The system of claim 2 wherein the pre-determined number of messages is less than 100.

4. The system of claim 1 wherein the set of device computer instruction include instructions for retrieving message information outside the first pre-determined distance and within a second pre-determined distance.

5. The system of claim 4 wherein the first pre-determined distance is about 30 meters and the second pre-determined distance is about 300 meters.

6. The system of claim 4 wherein the device computer readable instructions include instructions for retrieving message information outside the second pre-determined distance and within a third pre-determined distance.

7. The system of claim 6 wherein the first pre-determined distance is about 30 meters, the second pre-determined distance is about 300 meters and the third pre-determined distance is about 3000 meters.

8. The system of claim 1 wherein the device computer readable instructions include instructions to associate the device geolocation information with a received message and transmit the message and device geolocation information to a second recipient providing a retransmitted message.

9. The system of claim 8 wherein the device computer readable instructions include instructions to display the number of times the message is retransmitted.

10. The system of claim 8 wherein the device computer readable instructions include instructions to associate the device geolocation information with the received message, and transmit the message to user's within a first pre-determined distance of the device geolocation information.

11. The system of claim 10 wherein the device computer readable instructions include instructions to receive a retransmitted message from a second portable device and display the geolocation of the second portable device and the geolocation information of the message information of the retransmitted message.

12. The system of claim 1 wherein the portable device transmits the device geolocation information to the server at pre-determined intervals.

13. The system of claim 12 wherein the pre-determined interval is selected from the group consisting of 0, 5, 15 and 30 minutes.

14. The system of claim 1 wherein the first pre-determined distance is represented by a first circle surrounding the device geolocation information when displayed to a user.

15. The system of claim 6 wherein the device computer readable instructions include instructions for displaying a second circle representing the second pre-determined distance having a distance greater than the first circle.

16. The system of claim 1 wherein the device computer readable instructions include instructions for displaying potential recipients of message information where the recipient is located within a first pre-determined distance.

17. The system of claim 1 wherein the geolocation information is retrieved from the global positioning satellite information.

18. A system for communications between senders and recipients within a geographic location comprising:
a portable device having a transceiver, GPS receiver, display and device computer readable medium;
a server in communications with the portable device having a server computer readable medium;
a database of users records contained on a database in communications with the server wherein each user record includes a unique user id and is associated with a user's portable device; and,
a set of device computer readable instructions on the device computer readable medium for receiving device geolocation information, transmitting the device geolocation information to the server, retrieving messages associated with a user from the server having message geolocation information that are within a first distance of the portable device calculated according to the message geolocation information and the user current geolocation information, displaying the received user id, message and message geolocation information associated with each retrieved message on the device display.

19. The system of claim 18 wherein the message geolocation information is taken from the current location of the portable device when the message is created.

20. The system of claim 18 wherein the message geolocation information is initially taken from the current location of the portable device when the message is created then updated at a pre-determined interval based upon the device geolocation information.

21. A system for communications between senders and recipients within a geographic location comprising:
a portable device having a transceiver, GPS receiver, display and device computer readable medium;
a server in communications with the portable device having a server computer readable medium;
a database of records representing potential recipients in communications with the server wherein each record includes a unique user id and is associated with a user's portable device wherein each portable device includes current geolocation information; and,
a set of device computer readable instructions on the device computer readable medium for creating message, associating a broadcast distance with the message, transmitting the message to the server to deliver to users within a distance represented by the broadcast distance relative to the device geolocation information.
